(19) United States
(12) Patent Application Publication
(10) Pub. No.: US 2024/0091931 A1
(43) Pub. Date: Mar. 21, 2024

(54) HANDLING OF PIECE GOODS BY MEANS OF A SUCTION GRIPPING DEVICE

(71) Applicant: Körber Supply Chain Logistics GmbH, Konstanz (DE)

(72) Inventor: Marc Gwinner, Fellbach (DE)

(21) Appl. No.: 18/263,235

(22) PCT Filed: Dec. 14, 2021
(86) PCT No.: PCT/EP2021/085720

§ 371 Date: Jul. 27, 2023

(30) Foreign Application Priority Data
Jan. 28, 2021 (EP) 21154060.4

(51) Int. Cl. B25J 9/16; B25J 13/08; B25J 15/06

(52) U.S. Cl. CPC B25J 9/1612; B25J 9/1651; B25J 13/082; B25J 15/0625

(57) ABSTRACT

Handling of piece good via a suction gripping device for automated movement of a piece of material via a suction gripping device including docking a suction head of the suction gripping device onto the piece good and gripping the piece good via a vacuum generated in the suction head, automatically moving the suction gripper by automatically moving the suction head, generating an output signal via a load sensor, the output signal comprising information that includes gripping information, and which provides information on how securely the piece of material is held by the suction gripping device and adjusting at least one operating parameter of the suction gripping device as a function of the gripping information.

### BACKGROUND

The invention relates to the technical field of the automatic gripping and moving of piece goods by means of a suction gripping device.

Suction pads, also called vacuum pads, are devices, which grip and manipulates a piece of material by means of a vacuum generated in a suction head. The suction head can be a suction cup or a suction nozzle, for example. A vacuum pump, for example, can be used to generate the vacuum.

If unit loads, also known as objects or consignments in logistics jargon, such as packages or sealed plastic bags, are moved with a vacuum gripper, the holding force of the vacuum gripper and the mass to be moved limit the possible mass to be moved limits the possible dynamics. The following condition should be fulfilled in order to prevent the sinks from breaking off:

F_{inertia,gripping object}<F_{holding force},
where the force F_{inertia,gripping object} is the resulting force of gravitational force and inertial force due to acceleration.

Where F_{inertia,gripping object} is the inertial force acting on the piece goods due to acceleration and Fholding force is the force with which the suction pad holds the piece goods.

In simplified terms, therefore, during a Z-stroke, the following applies of a stroke vertically upwards:

m_{gripobject}*(az+g)<A_{Suctioncup}*Δpᵤ

where m_{gripobject} is the mass of the piece, a₂ is the acceleration of the piece in vertical direction upwards, g is the acceleration of the earth, A_{Suctioncup} is the contact surface of the suction cup and Δpᵤ is the difference of the atmospheric pressure in which the suction pad is located to the pressure in the suction pad.

Objects with a large mass must therefore be moved much more slowly than objects that are very light, so that they do not tear away from the suction pad. In order to reduce the dynamics to the moving object, it is necessary to know the mass of the object. In addition, the gripping force varies depending on the vacuum generated by the vacuum cup in the suction head due to internal and external influences.

The use of a suction pad is therefore often inefficient when it has to handle different objects, such as postal items with different and unknown weights.

If no information is available about the properties of the individual objects to be gripped, for example their mass and/or whether the object is a cardboard box or a plastic bag, the dynamics must be adapted to the type of object that is most unfavorable for suction gripping, for example to the largest possible mass. This results in a very low throughput during pick and place operations.

Tests in the laboratory have also shown that flexurally limp shipments, for example sealed bags, are very much false air, i.e. have a very large leakage, and the reduced pressure difference can lead to a half-bending of the holding force. This also results in a corresponding restriction of the dynamics.

It is also conceivable that the objects are weighed before gripping. However, this is very cumbersome and requires the presence of a scale and additional process steps.

It is also possible to use a vision system, for example a camera system, to determine the size of an object and, starting from a large object volume, to estimate a large object mass. This is, however, inaccurate and not possible with small, but heavy objects are likely to tear off the object from the suction pad.

### SUMMARY

The present invention is therefore based on the task of increasing the throughput of a suction gripping device.

This task is solved by the solutions presented in the independent claims. Advantageous embodiments of the invention are given in further claims.

According to one aspect, a method for automated movement of a piece of material by means of a suction gripping device is presented. A suction head of the suction gripping device is docked to the piece goods and the piece goods are gripped by means of a vacuum generated in the suction head. The gripped piece of material is then moved automatically by moving the suction head automatically. A load sensor generates an output signal that contains information on how securely the item is held by the suction gripper. This information is then the gripping information. At least one operating parameter of the suction gripping device is set depending on the gripping information.

According to one aspect, a suction gripping device for automatized movement of a piece of material. The suction gripping device comprises a suction head, a suction means, a load sensor, a movement means and a control means. The suction means, for example a vacuum pump, is designed to generate a vacuum in the suction cup. The Suction head is designed to dock onto a piece of material and grip it by means of a vacuum generated in the suction head. The moving means is designed to move the suction head and the piece of material gripped by the suction head automatically.

The load sensor is designed to generate an output signal that includes gripping information. The gripping information allows a statement to be made about how securely the piece goods are held by the suction head. The load sensor is designed to feed this output signal into the control means. The control means is designed to control the suction gripping device so that at least one operating parameter of the suction gripping device is set depending on the gripping information.

Setting an operating parameter can be done in a variety of ways, for example, the operating parameter can be increased, reduced, less increased than intended, less reduced than intended, limited, set to a predetermined value, regulated, controlled, or left as is.

According to one embodiment, the setting of the at least one operating parameter is carried out as part of a control process. In this way, the operating parameter during a period of movement of the piece goods by the suction gripping device can be controlled and adjusted on the basis of the gripping information obtained by the load sensor. For this purpose, the control means can comprise a control loop.

According to one embodiment, however, the setting of the at least one operating parameter can also be carried out as part of a pure control process, for example, by the suction gripper moving along a predefined movement profile on the basis of the stopping information. Here—for this purpose, the control means may include a control means.

According to one embodiment, the at least one operating parameter comprises an acceleration of the suction head. For this purpose, the control means can be designed to control the movement of the suction head in such a way that the acceleration of the suction head is set as a function of the gripping information. This makes it possible, for example, to limit an inertial force acting on the piece goods as a result of the movement of the suction head, by the acceleration of the suction head is limited. According to one embodiment, a vertical component of an acceleration of the suction head is set or limited as an operating parameter depending on the gripping information. Thus, in particular, a tear-off of the piece goods in vertical direction can be avoided, since a tear-off of the piece goods is to be expected to a greater extent in vertical direction, since the gravitational force also acts in this direction, and the control means is designed to control the movement means in such a way that the acceleration of the suction head is set as a function of the gripping information.

Limiting acceleration can include, for example, reducing, limiting, or increasing acceleration slower than intended.

According to one embodiment, the suction head comprises a structure designed to dock onto the piece goods and grip them by means of a vacuum, for example a suction cup or a suction nozzle. The negative pressure is in comparison to the atmospheric environment in which the suction gripping device is located.

According to an embodiment example, the at least one operating parameter comprises a pumping power of a vacuum pumping device which generates the vacuum. For this purpose, the control means can be configured to control the suction means configured as a vacuum pumping device in such a way that the suction power of the suction means is set as a function of the gripping information. For example, the vacuum pumping device can thus be operated at a medium power during normal operation. However, if the load sensor for a gripped piece of material supplies gripping information indicating that the piece of material is not being held sufficiently well, for example in that the gripping information falls below or exceeds a predefined threshold value, the pumping power is increased. This can ensure that the piece goods are held securely. Likewise, due to the increase in pumping power, the suction head can be accelerated more strongly in order to move the piece goods by means of the suction gripping device without the risk of the piece goods falling off the suction head.

According to one embodiment, the gripping information is dependent on an inertial force caused by the movement of the piece goods. This means that effects due to the mass of the workpiece can be taken into account when setting the operating parameters, e.g. gravitational force or the inertia of the piece goods. In this way, it can be prevented that the piece goods fall off the suction head due to excessive acceleration.

According to one embodiment, the gripping information is dependent on the vacuum prevailing in the suction gripping device. In this way, pressure-dependent circumstances, such as increased leakage, for example due to a shape, size, weight, pressure fluctuations caused by the vacuum pump and/or type of piece good can be taken into account in a simple manner in order to optimize the acceleration acting on the gripped piece good.

According to one embodiment, a type of piece goods is determined, for example whether the piece goods is a package or a bag, and the at least one operating parameter is set depending on the type of piece good determined.

According to one embodiment, the suction gripping device comprises a vision system, for example a camera system, which is designed to determine a property of the piece goods and feed it into the control means. This information is hereinafter referred to as piece goods property information. For example, the vision system can determine a size as piece goods property information, or whether the piece goods are a package or a bag. The control means is designed to control the suction gripping device in such a way that at least one operating parameter of the suction gripping device is set as a function of the piece goods property information.

According to an embodiment example, a type of the piece goods determines, for example, whether the piece good is a package or a bag, and includes automatically moving the piece good gripped by the suction pad, that an acceleration of the piece goods is set or adjusted depending on the determined type of piece goods. In this way, the acceleration can be adapted to the type of piece goods; for example, higher safety margins can be applied to bags and the acceleration can be limited earlier than would be useful for packages. In this way, the throughput of the suction gripper can be increased.

According to one embodiment, the load sensor is designed as a load switch that defines a threshold value, whereby the at least one operating parameter is set when the threshold value is exceeded or undershot. For example, this makes it easy to implement a control system that limits the acceleration of the suction head when the quality of holding the piece goods falls below a threshold value in order, on the one hand, to prevent the gripped piece goods from falling off the suction head due to inertia and, on the other hand, to ensure that the acceleration is not kept unnecessarily low so that the suction gripping device can be operated with the highest possible throughput.

According to one embodiment, the load sensor is designed to output an output signal that allows more than a pure threshold value decision, and the at least one operating parameter is set depending on an analog or quasi-analog value of the output signal. In this way, a control can be implemented which adapts the operating parameter to the respective grip information in a more differentiated manner.

According to one embodiment, the load sensor is arranged in the suction head.

According to embodiment examples, the output signal is an analog output signal. According to further embodiment examples, the output signal is a digital output signal.

### BRIEF DESCRIPTION OF THE DRAWINGS

In the following, the invention is described and explained in more detail with reference to the embodiments shown in the figures. Schematically shown therein:

FIGS. 1 to 4 show side views of a suction gripping device according to an embodiment example of the invention at different times to illustrate an execution example of the method for automated movement of the piece goods;

FIG. 5 shows a schematic side view of an exemplary suction gripping device 10 comparable with the one from FIG. 1-4;

FIG. 6 shows an example of a graphical representation of characteristics;

FIG. 7 shows an exemplary flow chart illustrating further embodiments of the invention; and

FIG. 8 shows a schematic side view of a suction head according to an embodiment.

### DETAILED DESCRIPTION

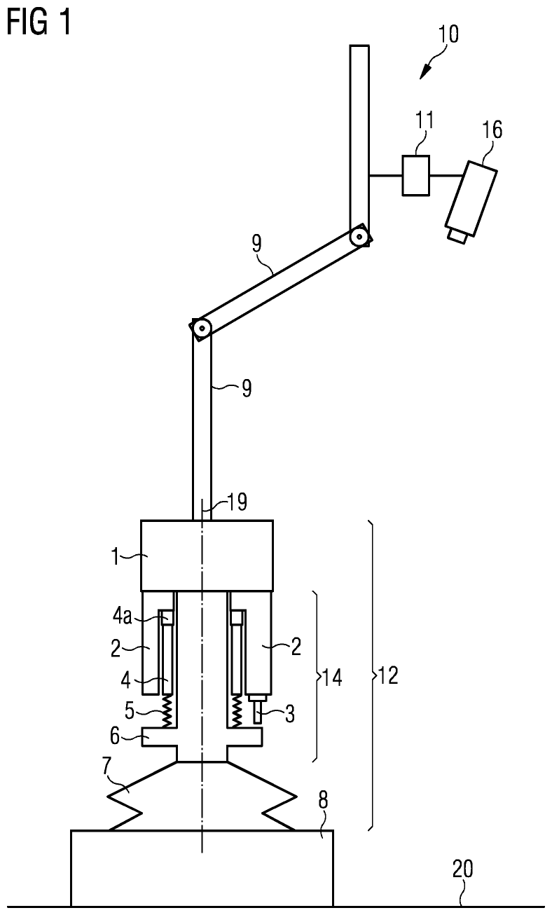

FIG. 1 shows a side view of suction gripping device 10 according to an embodiment of the invention. The suction gripping device 10 comprises a suction head 12, a moving means 9, a control means 11 and a vision system 16. The parts of the suction head are arranged rotationally symmetrically about a longitudinal axis 19, if reasonable. The suction head 12 comprises a suction means 1 designed as a vacuum pump or a valve connection 1a, a housing 2, a proximity switch 3, a sliding bush 4 with seal 4a, a spring system 5, a piston rod 6 with longitudinal vacuum feed-through, and a suction cup 7. The piston rod 6, also referred to simply as piston 6, and the suction cup 7 are designed and arranged in such a way that a channel is arranged in their interior through which a vacuum generated by the suction medium acts on an outlet of the suction cup, so that a piece of material can be docked at this suction cup outlet and gripped by the suction head 12 by means of the vacuum.

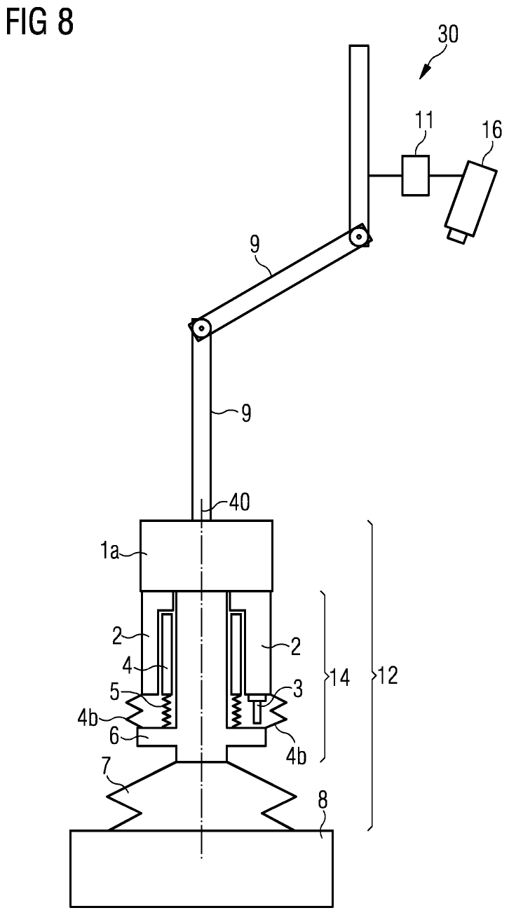

The piston rod 6 is designed to slide longitudinally in the sliding bushing, with a seal, for example in the form of a sealing ring 4a or a bellows 4b (see FIG. 8), and the housing 2 pneumatically shielding part of the piston rod from the ambient atmospheric pressure. When a negative pressure relative to the ambient atmospheric pressure is generated in the suction means 1 with the suction cup outlet sealed, a piston force acts in the longitudinal direction on the piston rod 6 in the direction of the suction means. The spring system 5 is designed and arranged in such a way that it causes a spring force acting on the piston rod 6 which counteracts the piston force.

The proximity switch 3 is designed and arranged in such a way that it can detect the movement of the piston rod 6. In the present example, the proximity switch 3 is coupled to a projection of the piston rod 6. To ensure a secure coupling, the proximity switch can be attached to the projection or pressed against the projection by means of a further spring system (not shown).

The moving means 9 is designed to automatically move the suction head 12 and the piece goods 8 gripped by the suction head 12. In the example illustrated in FIG. 1, the suction means 1 is integrated in the suction head 12 and is moved along with it. In one variant, the suction means is arranged remote from the suction head stationary or not traveling with the suction head and connected to the suction head 12 via a pneumatic line and a valve connection 1a arranged in the suction head to the housing 2.

The suction gripping device 10 also comprises a load sensor 14 which, in the embodiment example shown in FIG. 1, is connected to the housing 2, the piston rod 6, the spring system 5, the slide bushing 4 with the seal 4a, and in particular the proximity switch 3. As explained above, the proximity switch 3 is designed to travel with the piston rod 6 in the longitudinal direction. In addition, the proximity switch 3 is designed to send a signal to the control means 11 when a defined position is passed.

FIGS. 1-4 show, at different times, for illustration of an embodiment of the method for automated movement of a piece of material and for better understanding the operation of the exemplary suction gripping device 10. The process is controlled by the control system 11. For this purpose, the control system is connected electronically, by tracking technology and/or by radio to the suction means 1, the load sensor 14, the proximity switch 3, the movement means 9, and/or the vision system 16.

FIG. 1 shows the suction gripping device 10 at a point when the moving means 9 has moved the suction head 12 towards the piece goods 8 so that the suction cup 7 is attached to the piece goods 8. Together with or after docking, the piece goods 8 are gripped by means of a vacuum generated by the vacuum pump 1 in the suction head 12.

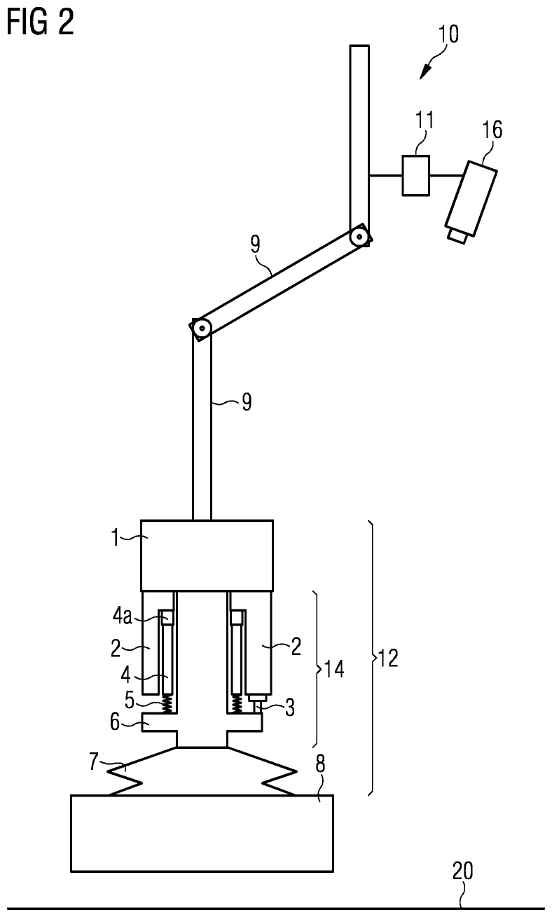

FIG. 2 shows the suction gripping device 10 with a vacuum built up in the suction head 12. The piece of material 8 has been lifted from the floor or other supporting surface 20. The suction cup 7 has contracted. In addition, the piston rod 6 was displaced upward due to the piston force described above and with the piston rod 6, the proximity switch 3 was displaced upward. As a result, a first output signal with a rising edge was generated by the proximity switch 3. The rising edge represents gripping information stating that the piece goods 8 are securely held by the suction head 12.

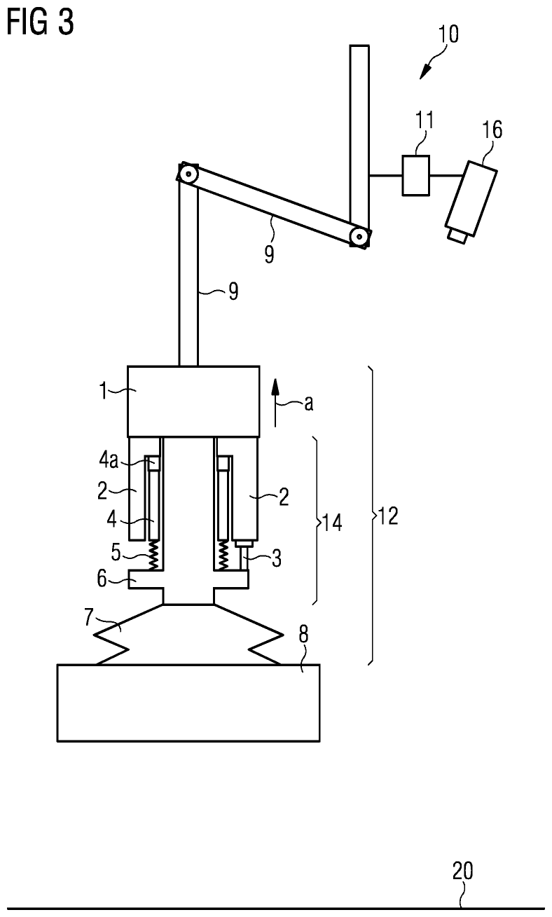

FIG. 3 shows the suction gripping device 10 at a subsequent point in time, at which the suction head 12 is moved vertically upwards by the movement means 9 with an acceleration a. The suction head 12 is moved vertically upwards by the movement means 9 with an acceleration a. The suction head 12 is then moved vertically upwards by the movement means 9. Due to the inertia of the piece goods, an inertial force acts against the piston force, causing the suction head to move lengthwise again and, in particular, the piston rod 6 and with it the proximity switch 3 to move downward relative to the housing 2, causing the proximity switch 3 to generate a second output signal with a falling edge. The falling edge represents gripping information stating that the piece of material 8 is not securely held by the suction head 12. Thus, the load sensor 14 is configured to generate an output signal comprising information about how securely the piece goods 8 are held by the suction head 12.

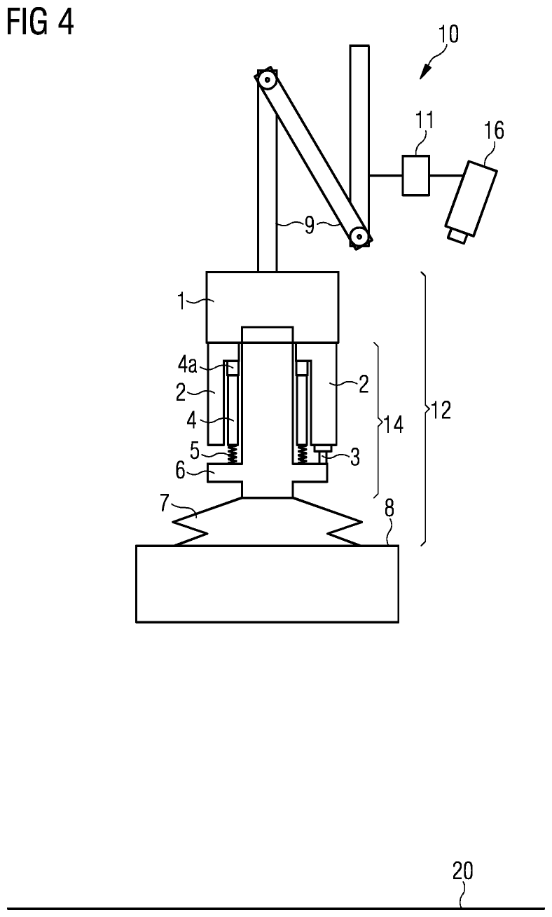

FIG. 4 shows the suction gripping device 10 at a subsequent time at which the acceleration of the suction head 12 in the vertical direction has been reduced on the basis of the second output signal, i.e. on the basis of the gripping information which states that the piece of material 8 is not being held securely by the suction head 12. This reduces the inertial force acting against the piston force, and the proximity switch 3 generates a third output signal with a rising edge. As in FIG. 2, the rising edge represents gripping information which indicates that the piece of material 8 is held securely by the suction head 12.

The control means 11 is thus configured to control the suction gripping device 10 in such a way that at least one operating parameter of the suction gripping device 10, namely the acceleration of the suction head 12, is set as a function of the gripping information. Alternatively, or in addition thereto, the control means 11 may, for example, be configured to control the suction means 1 in such a way that the suction power of the suction means 1 is adjusted as a function of the gripping information. For example, the suction power can be increased if the gripping information indicates an unsafe holding of the piece goods. In addition to the more secure gripping of the piece goods made possible in this way, the effective suction power can be adapted to the required suction power, which saves energy and reduces wear on the vacuum pump.

By mechanically incorporating the pressure level at the suction cup, a pressure-dependent load sensor 14 can be realized according to the design example shown in FIGS. 1 to 4, which operates according to the same physical principle as the actual vacuum gripper. In this case, the construction consists of the piston 6 with vacuum feedthrough. The piston 6 runs in a guide 4, which seals between the housing 2 and piston 6 and permits relative movement. Sealing takes place between the atmospheric pressure from outside and the pressure in the vacuum cup 1. If the vacuum in the suction head changes during gripping, the change in the holding force has a proportional effect on the change in the tripping force of the load switch 3. Optionally, a defined triggering characteristic can be set by the spring 5. The position of the piston 6 is thus detected by a simple proximity switch 3. A travel distance of 2 mm is sufficient for the sensor to output a binary signal in the event of an overload. Optionally, a longer travel distance can be used for more information, for example for analog travel measurement.

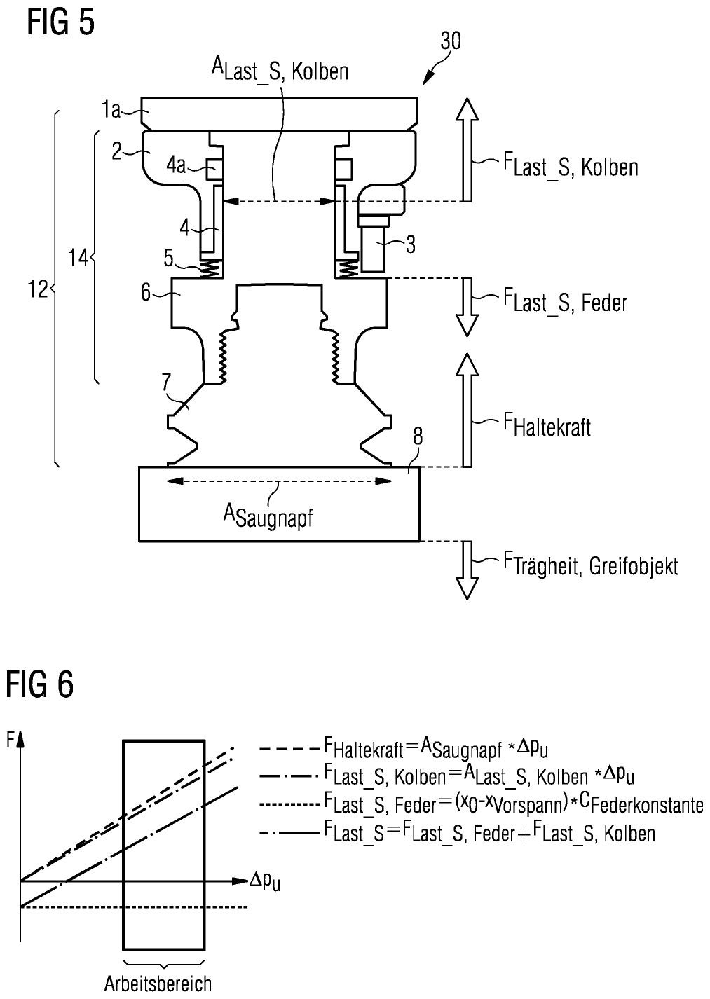

FIG. 5 shows a schematic side view of a suction gripping device 30 comparable to that of FIGS. 1-4 to explain the physical forces involved. The suction gripping device comprises a valve connection 1a, a housing 2, a proximity switch 3, a sliding bush 4 with sealing ring 4a, a spring system 5, a piston rod 6 with vacuum feed-through, a suction cup 7, and an object to be gripped as a piece good 8 or other object with mass m. The pneumatically effective area A_{suctioncup} of the suction cup and the pneumatically effective area A_{load_S,piston} of the piston are also drawn. The pressure-independent load switch is based on the following physical principles:

The pressure dependence for the load switch is achieved by the piston cross-section of the load switch:

F_{Load_S,piston}=A_{Load_S,piston}*Δpᵤ

Optionally, a defined preload force can be set by the spring:

F_{Load_S,Spring}=(x₀−x_{preload})*C_{Springconstant}

In combination between spring and piston and results in the following equation for the load switch:

F_{Load_S}=F_{Load_S,piston}+F_{Load_S,spring}=A_{Load_S,piston}*Δpᵤ−(x₀−x_{preload})*C_{Springconstant}

Where the symbols used in the equation have the following meaning:
F_{Load_S,piston} the pneumatic piston force;
A_{Load_S,piston} to atmosphere sealed cross-sectional area of the piston;
Δpᵤ is the pressure difference between the vacuum in the suction head and the atmospheric pressure;
F_{Load_S,Spring} the preload force of the spring;
x₀ is the initial length of the spring in unloaded condition;
x_{preload} is the length of the preloaded spring in the loaded state;
C_{Springconstant} the spring constant;
F_{Load_S} trigger threshold of the load switch.

FIG. 6 shows the dependence of the holding force and the load switch on the pressure.

According to one embodiment, the vacuum at the vacuum gripper is used to realize a pressure-dependent force balance, for the pressure-dependent characterization of the load or mass of the piece goods. The following advantages can be a result of this:

Simple, cost-effective and compact design to characterize the mass properties normalized to pressure for significant optimization of dynamics and throughput.

Prevention of dropping of the piece goods during the loading of the piece goods with a vacuum gripper;

Easy adjustment or design of the release characteristics of the load switch by changing the cross-section and the spring preload force;

Determination of a successful gripping process/detection when a consignment falls off;

Additional function: Jolt damper by movement of the piston in case of overload in effective direction.

According to a further variant, the load sensor is not designed as a sensor that takes gravity and inertial forces into account, as shown in FIGS. 1-6, but as a pure pressure sensor that is arranged in a suction head designed as a simple suction cup and is designed to send a signal representing the current pressure or vacuum in the suction head to the control means 11. The current pressure or negative pressure also allows a statement to be made about how securely a piece of material is held. If the vacuum is too low, i.e. the pressure in the suction cup is too high, this can indicate leakage between the suction cup and the piece goods, in particular if the suction cup is not moved or is moved with a defined acceleration.

According to another embodiment, the suction head does not comprise a piston 6, but only a load switch which is coupled to the suction cup of the suction gripping device and which detects the deformation of the suction cup caused by the vacuum. From this, gripping information can be derived that allows a statement to be made about how well the gripped piece of material is held by the suction gripping device. This load switch can optionally comprise a spring so that the load switch moves along with the suction cup as reproducibly as possible. This has the disadvantage that the solution is more difficult to implement with high precision.

In contrast, design examples such as the suction gripping device shown in FIGS. 1 to 5 have the advantage that the suction gripping device can be used for the following purposes part that by means of the spring characteristic and the ratio of the cross-sectional area of the piston sealed to the atmosphere to the sealing area of the suction cup, the characteristics of the sensor can be adjusted very precisely by design.

According to one embodiment, the sensor information from the vision system and load switch can be combined in combination with a vision system. For example, the following gripping strategy can be used:

1. characterization of vision system between bag/carton and size;

2. gripping the consignment until the load switch gives signal;

3. move the previously characterized consignment upwards (e.g. +Z 200 mm) with suitable acceleration characteristic to release the consignments from the bulk;

4. when the load sensor triggers, a calculation of instantaneous acceleration is made, taking into account the trigger delay and other parameters, to determine a final valid dynamic of further movement.

(Alternative: Simple distinction between light and heavy (critical) shipment);

5. execute remaining motion sequence according to calculated dynamics+monitoring by load switch.

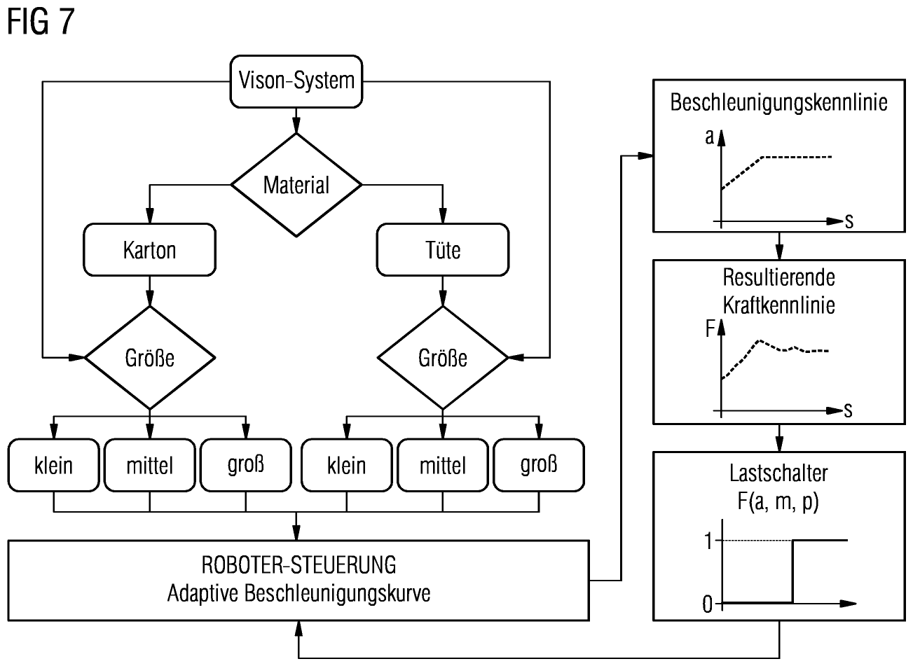

FIG. 7 shows a further example of a method and a suction gripping device which is set up to carry out the steps according to the method. Thereby a vision system, the type of item to be gripped, in particular whether it is a cardboard box or a bag. A cardboard box is generally better held by the suction gripping device, while a bag leads to increased leakage between the suction cup and the piece goods. Likewise, the size of the piece goods can be determined, and an operating parameter of the suction pad designed as a robot can be adapted accordingly by the robot controller selecting, determining and/or determining an adaptive acceleration curve according to which the suction head is to be moved. If the load switch reports that the lump material threatens to tear off the suction cup, operating parameters such as the acceleration curve or the suction power are adjusted.

FIG. 8 shows an embodiment of a suction gripping device 30 which is similar in many aspects to the suction gripping device 10 of FIG. 1, but in which the piston rod 6 is not sealed from the atmosphere by a sealing ring 4a, but by means of a bellows 4b arranged around the longitudinal axis 40 between the housing 2 and the piston rod 6.

Also, the suction head 14 of the suction gripping device 30 comprises only a valve connection 1a and not an entire vacuum pump. In this case, the vacuum pump can be set apart from the suction head, for example, be arranged in a stationary position, and feed the vacuum generated by the vacuum pump into the suction head via a pneumatic line.

According to a further embodiment, a method for the automated movement of a piece of material by means of a suction pad is presented. A suction head of the suction gripper is docked onto the piece goods and the piece goods are gripped by means of a vacuum generated in the suction head. The gripped piece goods are then moved automatically by moving the suction head automatically. A load sensor generates an output signal that includes information on whether the piece goods are in danger of falling off the suction head. The automatic movement of the suction head is performed in a controlled manner by limiting the acceleration of the suction head depending on the information as to whether there is a risk of the piece goods falling off the suction head.

According to one embodiment, the information as to whether there is a risk of the piece goods falling off the suction head is dependent on the presence and/or extent of leakage between the piece goods and the suction cup docked to the piece goods.

According to one embodiment, the load sensor is arranged in the suction head. This enables a compact design of the suction pad.

According to one embodiment, the load sensor is designed as a load switch that defines a threshold value, whereby the acceleration of the suction head is limited when the threshold value is exceeded or not reached. This enables a particularly simple but nevertheless effective construction and operation of the suction pad. For example, the threshold value can be set as a setpoint value for the vacuum, below which (i.e. below the pressure difference between the atmospheric ambient pressure and the pressure in the suction head) the acceleration of the suction head and thus of the piece goods gripped by the suction head is limited in order to prevent the piece goods from being torn off the suction head in time.

According to a further embodiment, a method for the automated movement of a piece of material by means of a suction pad is presented. A suction head of the suction gripper is docked onto the piece goods and the piece goods are gripped by means of a vacuum generated in the suction head. The gripped piece good is then moved automatically by moving the suction head automatically. A load sensor generates an output signal that includes information on whether the piece goods are in danger of falling off the suction head. The automatic movement of the suction head is performed in a controlled manner by limiting the acceleration of the suction head depending on the information as to whether there is a risk of the piece goods falling off the suction head.

In this way, piece goods with increased throughput can be moved in an automated manner by means of a suction pad, by limiting the acceleration of a piece good gripped by the suction pad before it breaks away from the suction head of the suction pad.

According to an embodiment example, a method for automated movement of a piece of material by means of a suction pad is presented. A suction head of the suction gripper is docked onto the piece goods and the piece goods are gripped by means of a vacuum generated in the suction head. The gripped piece is then moved automatically by moving the suction head automatically. A load sensor generates an output signal that is dependent on the vacuum prevailing in the suction pad. The automatic movement of the suction head is performed in a controlled manner by limiting the acceleration of the suction head depending on the output signal and the vacuum prevailing in the suction pad.

1.-14. (canceled)

15. A method for automated movement of a piece good via a suction gripping device, comprising:
docking a suction head of the suction gripping device onto the piece good and gripping the piece good via a vacuum generated in the suction head;
automatically moving the piece good gripped by the suction gripping devices by automatically moving the suction head;
generating an output signal via a load sensor, the output signal comprising an information item of gripping information as to how securely the piece good is held by the suction gripping device; and
setting at least one operating parameter of the suction gripping device as a function of the gripping information.

16. The method according to claim 15, wherein the at least one operating parameter comprises an acceleration of the suction head.

17. The method according to claim 16, wherein the at least one operating parameter comprises a pumping power of a vacuum pumping device which generates a negative pressure in the suction gripping device.

18. The method according to claim 17, wherein the gripping information is dependent on an inertial force produced by the movement of the piece and/or dependent on a mass of the piece good.

19. The method according to claim 18, wherein the gripping information is dependent on the negative pressure in the suction gripping device.

20. The method according to claim 19, wherein a type of the piece good is determined whether the piece good is a package or a bag, and the at least one operating parameter is set depending on the determined type of the piece good.

21. The method according to claim 15, wherein the at least one operating parameter comprises a pumping power of a vacuum pumping device which generates a negative pressure in the suction gripping device.

22. The method according to claim 15, wherein the gripping information is dependent on an inertial force produced by the movement of the piece and/or dependent on a mass of the piece good.

23. The method according to claim 15, wherein the gripping information is dependent on a negative pressure in the suction gripping device.

24. The method according to claim 15, wherein a type of the piece good is determined whether the piece good is a package or a bag, and the at least one operating parameter is set depending on the determined type of the piece good.

25. A suction gripping device comprising:
a suction head;
a suction generator;
a load sensor;
a movement agent; and
a controlling agent;
wherein the suction generator is configured to generate a negative pressure in the suction head;
wherein the suction head is configured to be docked with a piece good and to grip the piece good via the negative pressure generated in the suction head;
wherein the movement agent is configured to automatically move the suction head and the piece good gripped by the suction head;
wherein the load sensor is configured to generate an output signal comprising information that includes gripping information, which permits a statement to be made as to how securely the piece good are held by the suction head;
wherein the load sensor is configured to feed the output signal into the controlling agent;
wherein the controlling agent is configured to control the suction gripping device such that at least one operating parameter of the suction gripping device is adjusted in dependence on the gripping information; and
wherein the suction gripping device is configured to determine a type of the piece good and to control the automatic movement of the piece good gripped by the suction gripping device such that a slowing down of the piece good is set or adjusted depending on the determined type of the piece good.

26. The suction gripping device according to claim 25, wherein the at least one operating parameter comprises an acceleration of the suction head and the controlling agent is configured to control the movement agent such that the acceleration of the suction head is adjusted in dependence on the gripping information.

27. The suction gripping device according to claim 26, wherein the at least one operating parameter comprises a suction power of the suction generator, and wherein the controlling agent is configured to control the suction generator such that the suction power of the suction generator is adjusted in dependence on the gripping information.

28. The suction gripping device according to claim 27, wherein the gripping information is dependent on an inertial force produced by the movement of the piece good and/or dependent on a mass of the piece good.

29. The suction gripping device according to claim 28, wherein the gripping information is dependent on a vacuum prevailing in the suction head.

30. The suction gripping device according to claim 26, further comprising:
a vision system configured to determine a property of the piece good and to feed information characterizing the property that includes piece good property information into the controlling agent, and wherein the controlling agent is configured to control the suction gripping device such that the at least one operating parameter of the suction gripping device is set in dependence on the piece good property information.

31. The suction gripping device according to claim 26, wherein the load sensor is configured as a load switch comprising a threshold value, and wherein the at least one operating parameter is set when the threshold value is exceeded or undershot.

32. The suction gripping device according to claim 26, wherein the load sensor is configured to output an output signal which permits more than a pure threshold value decision, and the at least one operating parameter is set as a function of an analog or quasi-analog value of the output signal.

33. The suction gripping device according to claim 26, wherein the gripping information is dependent on an inertial force produced by the movement of the piece good and/or dependent on a mass of the piece good.

34. The suction gripping device according to claim 26, wherein the gripping information is dependent on a vacuum prevailing in the suction head.
